(19) United States
(12) Patent Application Publication
(10) Pub. No.: US 2020/0311619 A1
(43) Pub. Date: Oct. 1, 2020

(54) SYSTEMS AND METHODS TO SUGGEST ROOM SWAP FOR MEETING

(71) Applicant: Lenovo (Singapore) Pte. Ltd., Singapore (SG)

(72) Inventors: Axel Ramirez Flores, Cary, NC (US); Russell Speight VanBlon, Raleigh, NC (US); Jonathan Jen-Wei Yu, Raleigh, NC (US); Aaron M. Stewart, Raleigh, NC (US); Jonathan Co Lee, Cary, NC (US); Rodrigo Felix de Almeida, Raleigh, NC (US); James A. Hunt, Chapel Hill, NC (US)

(21) Appl. No.: 16/370,378

(22) Filed: Mar. 29, 2019

(51) Int. Cl. G06Q 10/02; G06F 9/54

(52) U.S. Cl. CPC G06Q 10/02; G06F 9/542

(57) ABSTRACT

In one aspect, a device includes at least one processor and storage accessible to the at least one processor. The storage includes instructions executable by the at least one processor to identify at least one factor related to an electronic reservation for a first meeting room and to provide an electronic notification suggesting a room swap to a second meeting room.

### FIELD

The present application relates to technically inventive, non-routine solutions that are necessarily rooted in computer technology and that produce concrete technical improvements.

### BACKGROUND

As recognized herein, electronic reservation systems are often used to reserve a conference room for a meeting. However, as also understood herein, there might be times when a person is already using the conference room by themselves or with others during the same time, but without indicating conference room use in the electronic reservation system. Thus, when another person that reserved the room for that time via the electronic reservation system arrives at the conference room along with other participants for the scheduled meeting, that person will find the room already taken. This can be frustrating to the participants of one or both meetings since one group of them will have to find another conference room for their respective meeting.

The present application recognizes that frustrations might also occur when, for example, one group of people has reserved a conference room via an electronic reservation system but are not using all the resources available in that conference room that another group of people might wish to use. For example, the present application recognizes that the people might be talking amongst each other but not using a display or conference phone located within the conference room. At the same time, another group of people might wish to meet but there might not be another room available through the electronic reservation system that meets the needs of their meeting, such as the need for a conference phone and the need to present content on a display mounted within the room.

There are currently no adequate solutions to the foregoing computer-related, technological problem.

### SUMMARY

Accordingly, in one aspect a first device includes at least one processor and storage accessible to the at least one processor. The storage includes instructions executable by the at least one processor to identify at least one factor related to an electronic reservation for a first meeting room and to provide an electronic notification suggesting a room swap to a second meeting room for the electronic reservation, where the second meeting room is different from the first meeting room.

In some embodiments, the instructions may be executable to provide the electronic notification by transmitting the electronic notification to a second device that is associated with a person that created the electronic reservation, and/or by presenting the electronic notification on a display.

The instructions may also be executable to identify at least one meeting requirement based on input from a user that created the electronic reservation, where the at least one meeting requirement may at least in part establish the at least one factor. The instructions may then be executable to provide the electronic notification suggesting the room swap to the second meeting room based on the second meeting room conforming to the at least one meeting requirement. In some examples, the at least one meeting requirement may pertain to physical space for accommodating a number of in-person meeting participants, a particular building in which a meeting is to be held, and/or a particular floor of a particular building in which the meeting is to be held. Additionally, or alternatively, the at least one meeting requirement may pertain to availability of at least one room resource specified by the user, such as a white board, a conference phone device, and/or a display. Still further, in some embodiments the at least one meeting requirement may pertain to room availability for a particular date and time.

Also, in some embodiments, the electronic notification may include a selector that is selectable to accept the room swap.

In another aspect, a method includes identifying at least one need related to a meeting that is associated with a first meeting location, with the need indicated in an electronic reservation system. The method also includes providing an electronic notification suggesting a swap to conduct the meeting at a second meeting location instead of the first meeting location, with the second meeting location being different from the first meeting location.

In still another aspect, a computer readable storage medium (CRSM) that is not a transitory signal includes instructions executable by at least one processor to determine a first location for a first meeting based on one or more meeting needs indicated by a first user. The instructions are also executable to provide an electronic notification to a device associated with a second user, with the electronic notification indicating a location swap for a second meeting already scheduled to occur at the first location at a same date and same time as the first meeting. The location swap is from the first location to a second location different from the first location.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example network of devices in accordance with present principles;

FIG. 3 shows an example hub device in accordance with present principles;

FIG. 4 is a flow chart of an example algorithm for swapping rooms in accordance with present principles;

FIGS. 5-10 show various graphical user interfaces (GUIs) including notifications that may be presented in relation to room swapping in accordance with present principles; and

FIG. 11 is an example graphical user interface (GUI) for configuring settings of a device undertaking present principles.

### DETAILED DESCRIPTION

The present application relates to allowing users to be notified of possible swap opportunities for meetings in which they are or will be participating and allowing the users to accept or reject the suggested room swap. For example, a device undertaking present principles may identify information related to meeting participants (e.g., how many participants, which ones are local versus remote participants) as well as information related to resources (e.g., room is actually available, room has TV, room has whiteboard) to help end users swap existing room reservations.

For example, a device operating in accordance with present principles may automatically suggest people that can be considered remote and hence not be counted against room capacity (e.g. the room in the United States, but a participant chat/unified communication presence or employee directory location shows one of the meeting participants is in China). As another example, the device may identify all possible room options-based room requirements from both the person searching for a room and for the people that already have reserved rooms.

Existing room holders may then be automatically notified of a potential room swap opportunity based on, e.g., both meetings' time, date and amount of local participants. In some examples, the notification may also be based on both meetings' location threshold (e.g., same floor, same building, same campus, etc.).

Existing room holders may then be allowed to accept or reject the swap, and/or the swap may be automatically performed, and the existing meeting invite for a given meeting may be updated to indicate the newly-assigned room resulting from the swap. Thus, a person searching for a room that meets certain requirements for a given meeting may be able to book a suitable room.

In accordance with present principles, software systems may thus be configured to automatically negotiate room swaps and to determine what is needed for a given meeting to occur at a given location (e.g., participants in China do not count against local capacity of a room in the United States that is being booked).

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C # or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

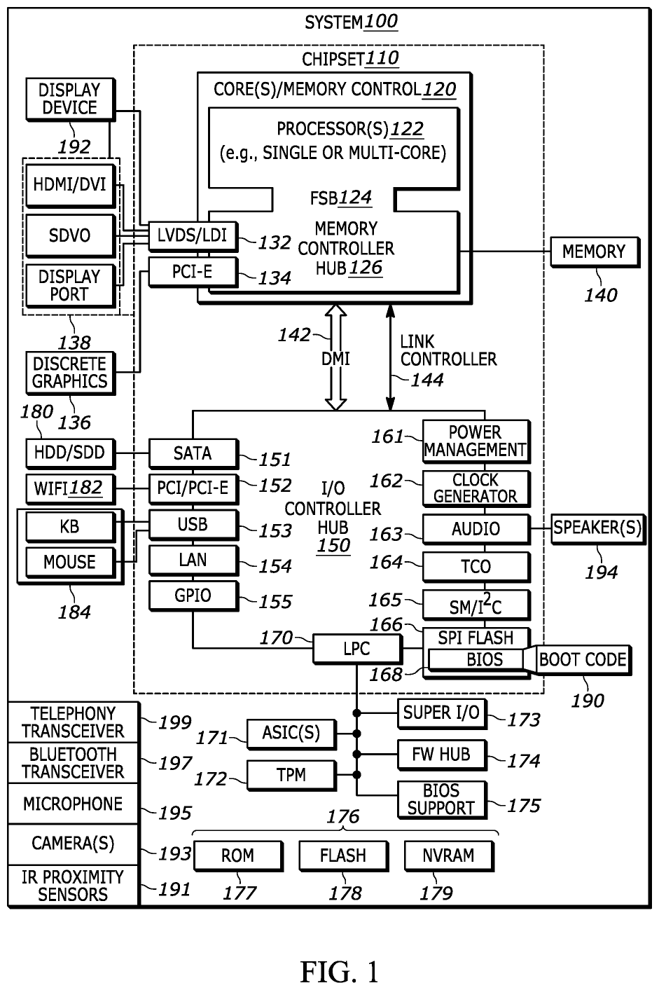

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.” The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, the system 100 may include one or more sensors accessible to the one or more processors 122 so that input from the one or more sensors may be provided to the one or more processors 122. For example, the system 100 may include one or more infrared (IR) proximity sensors 191, one or more cameras 193, one or more microphones 195, and/or one or more Bluetooth communication transceivers 197. The cameras 193 may be, for example, thermal imaging cameras, infrared (IR) cameras, digital cameras such as webcams, three-dimensional (3D) cameras, and/or cameras otherwise integrated into the system 100 and controllable by the processor 122 to gather pictures/images and/or video. The one or more Bluetooth communication transceivers 197 may be classic Bluetooth transceivers and/or Bluetooth low energy (BLE) transceivers (e.g., Bluetooth 4.0 transceivers) for communicating with other devices using Bluetooth communication protocols.

Still further, a wireless telephony transceiver 199 may also be included in the system 100 as another example of a sensor in accordance with present principles. The telephony transceiver 199 may be a wired or wireless telephony transceiver, such as a wireless cellular telephone transceiver for wireless cellular communication over a cellular telephone network as well as other telephone networks.

Additionally, though not shown for simplicity, in some embodiments the system 100 may include other sensors such as a gyroscope that senses and/or measures the orientation of the system 100 and provides input related thereto to the processor 122, as well as an accelerometer that senses acceleration and/or movement of the system 100 and provides input related thereto to the processor 122. Also, the system 100 may include a GPS transceiver (another example of a sensor in accordance with present principles) that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

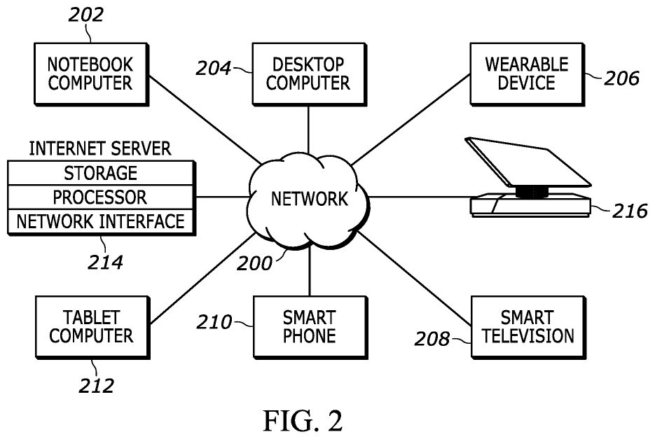

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a conferencing hub device 216, and a server 214. The server 214 may be, for example, as an Internet server that may provide cloud storage accessible to the devices 202-212, 216 and that may also execute and manage an electronic reservation system/software in accordance with present principles. It is to be understood that the devices 202-216 are configured to communicate with each other over the network 200 to undertake present principles. Moreover, some or all of the devices 202-216 may be, for example, located within a same conference room as each other.

Describing the conferencing hub device 216 in more detail, it may be, for example an IP conference phone, a Lenovo ThinkSmart Hub 500, and/or a Lenovo ThinkSmart Hub 700 that communicates with the server 214 that operates some or all of the electronic reservation system/software. Furthermore, the conferencing hub device 216 may include, for example, one or more processors, one or more of the sensors such as the ones referenced herein, one or more touch-enabled displays, one or more storage areas, a keypad for telephone dialing, a speaker for providing audio, etc.

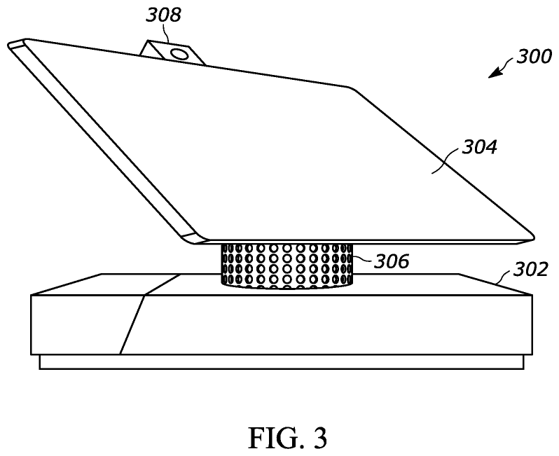

Now in reference to FIG. 3, it shows another example hub device 300 that may be similar to the hub device 216 described above. The hub device 300 may include a hub base 302 in which one or more system components may be housed, such as one or more processors, RAM, one or more storage areas, a microphone for detecting sound, etc. The base 302 may be connected to a touch-sensitive display 304 via cylinder 306, with the cylinder 306 itself including, e.g., a speaker for providing audio. Coupled to the display 304 may be one or more sensors 308 such as one or more infrared (IR) proximity sensors and/or one or more cameras, though the sensors 308 may be located elsewhere on the device 300 as well.

The display 304 itself may be rotatably coupled to the cylinder 306 for rotation in three dimensions so that, for example, it may be oriented at an oblique angle relative to the base 302 and any surface on which the base 302 may be placed as shown in FIG. 3. Additional orientations in which the display 304 may be rotated with respect to the base 302 include the display 304 being rotated such that its front surface is perpendicular to the top surface of the base 302 and the display 304 being rotated such that its front surface establishes a plane parallel to the top surface of the base 302.

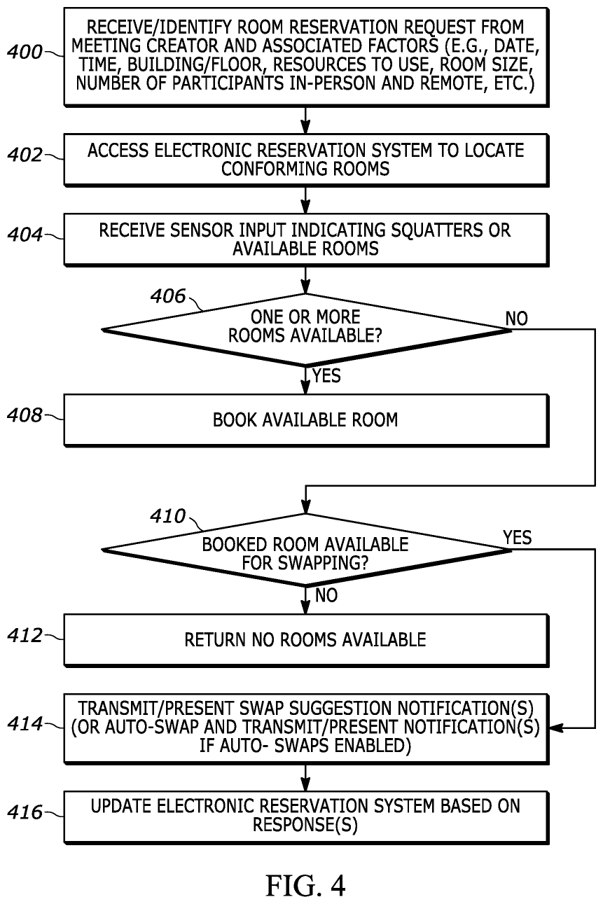

Referring to FIG. 4, it shows example logic that may be executed individually or jointly by a device such as a conferencing hub device like the devices 216, 300 and/or a server like the server 214 in order to perform room swaps for various meetings and to perform other actions as described herein. Beginning at block 400, the device may receive and/or identify a room reservation request from a meeting creator (a person) that wishes to reserve a conference room for a meeting. The device may also identify one or more factors related to the request at block 400, such as a date and time for the meeting, a particular building and/or particular floor of a building in which the meeting is to take place, room resources that will be used during the meeting, a requested room size, a number of in-person meeting participants and also a number of remote participants that will call into the meeting instead of attending in person, etc. The device may receive and/or identify the foregoing at block 400 based on input from a user directed to a graphical user interface (GUI) that has, e.g., input fields or check boxes for providing such input.

From block 400 the logic may proceed to block 402 where the device may access an electronic reservation system to identify one or more rooms that conform to the request and factors. For example, the electronic reservation system may be maintained at a server and, based on configuration by a system administrator, contain a database of rooms and data associated with each room, such as a particular building and/or particular floor of a building in which a given room is located, room resources for a given room, a square footage measurement for room size and number of people permitted for that square footage, etc. The electronic reservation system may also include an electronic calendar indicating a schedule for each room, including whether the room is reserved or available at various timeslots. Thus, at block 402 the device may use the information received or identified at block 400 and compare it to the database(s) and/or calendar(s) of the electronic reservation system to determine which rooms meet the criteria specified at block 400.

From block 402 the logic may then proceed to block 404 where the device may receive input from sensors in one or more (e.g., all) rooms for which reservations may be managed through the electronic reservation system to determine if, despite not reserving a given room through the electronic reservation system for a given timeslot, someone might still be located in that room during the timeslot. This may be useful for, e.g., booking immediate use of a given room and hence determining which rooms might still be occupied though not reserved through the electronic reservation system. This might also be useful for, e.g., scheduling a meeting for the future through the electronic reservation system and indicating to a current squatter within the room that the room should be vacated by the scheduled start time of the meeting. The sensor input itself that is received at block 404 may be from sensors on or otherwise in communication with respective hub devices disposed within the respective rooms, such as cameras or infrared (IR) proximity sensors.

The logic of FIG. 4 may then proceed to decision diamond 406 where the device may determine, based on the electronic reservation system accessed at block 402 and sensor input received at block 404, whether one or more rooms are available for the requested date and time and conform to the factors specified by the creator. Thus, for example, at diamond 406 the device may access the electronic reservation system to identify conforming rooms indicated as available during the requested date and time, while also executing IR proximity sensor software to identify any human bodies detected by IR proximity sensors on respective hub devices within the respective rooms. Additionally, or alternatively, object recognition software and/or facial recognition software may be executed to identify one or more faces or people that might be located within the respective rooms, should the sensor input received at block 404 include camera input from cameras disposed on respective hub devices in the respective rooms.

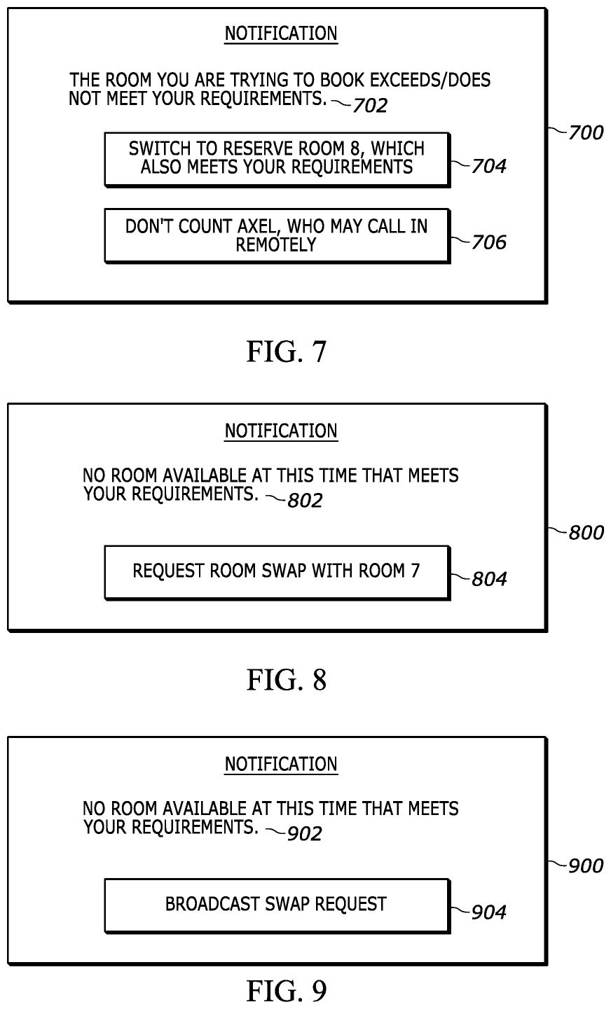

An affirmative determination at diamond 406 may cause the logic to proceed to block 408 where the device may book a room identified as available/unoccupied. Additionally, or alternatively, an affirmative determination at diamond 406 may cause the device to undertake the functions discussed below in reference to FIG. 7.

However, responsive to a negative determination at diamond 406, the logic may instead proceed from diamond 406 to decision diamond 410. At decision diamond 410, the device may determine whether any room that might already be booked during the requested date and time from block 400 nonetheless conforms to other factors from block 400 and hence might be available for room swapping. For example, even if a given room is already booked, it might still have room resources such as a non-electronic white board or chalk board, a conference phone device, a display (e.g., TV mounted on a wall), etc. requested by the meeting creator and might still be on a particular floor of a particular building requested by the meeting creator. The device may do so at diamond 410, e.g., by accessing the electronic reservation system and comparing the information received or identified at block 400 (other than meeting date and time) to the database(s) and/or calendar(s) of the electronic reservation system to determine which rooms meet the non-date/time criteria specified at block 400.

If it is determined at diamond 410 that no rooms that have already been booked for other matters meet the other factors/criteria specified by the creator, the logic may move to block 412 where the device may indicate to the creator that no rooms are available for booking at the requested date and time. For example, at block 412 the device may indicate as much via text presented on a display of a device being used by the creator to make the reservation, and/or via audio presented through one or more speakers on the device being used by the creator to make the reservation.

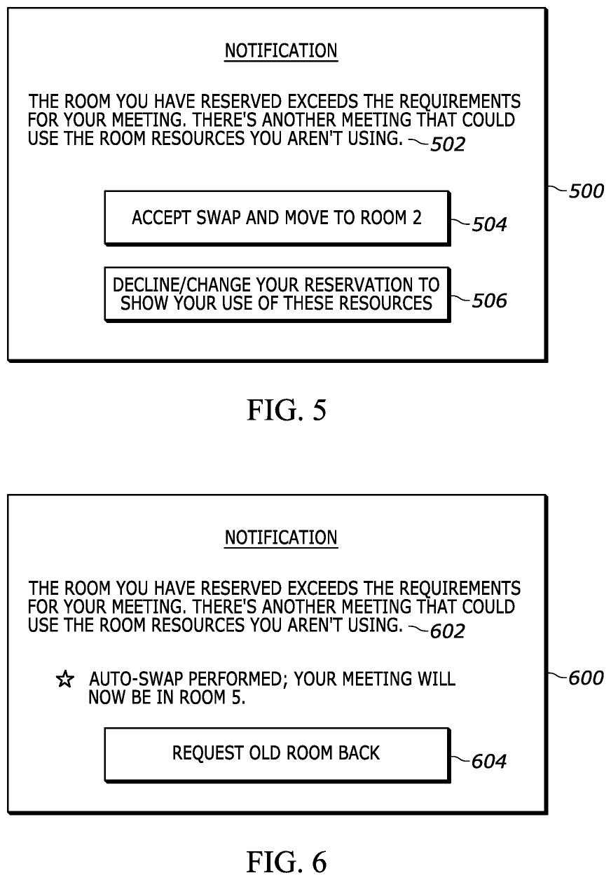

However, responsive to an affirmative determination at diamond 410, the logic may instead proceed to block 414 where the device may transmit and/or present swap suggestion notifications. For example, these notifications may be transmitted by a server or hub device that has access to the electronic reservation system to both the creator's personal device and/or the personal device of another person associated with another meeting scheduled to occur at the same date and time for which a room swap is being suggested. The notifications may then be presented at those respective personal devices. Examples of these notifications will be discussed below in reference to FIGS. 5, 8, and 9.

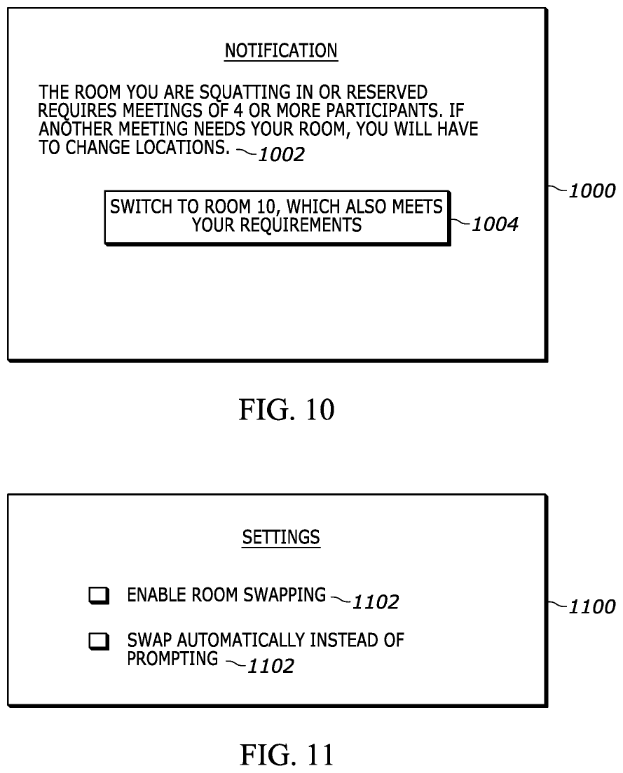

Additionally, or alternatively, at block 414 the device may automatically switch rooms for the respective meetings in the electronic reservation system. In such instances, also at block 414 the device may transmit and/or present notifications indicating the automatic switch, such as the notifications described below in reference to FIGS. 6 and 10.

After block 414 the logic may proceed to block 416. At bock 416 the device may update the electronic reservation system based on the automatic switches and/or any responses from respective meeting creators to swap requests.

FIG. 5 shows an example graphical user interface (GUI) 500 in accordance with present principles that includes a notification 502 that might be presented on the personal device of a meeting creator that has already booked a room for a given meeting but is being requested to swap rooms for his/her meeting with another meeting. As may be appreciated from FIG. 5, the notification 502 may indicate that the room the creator has reserved exceeds the requirements for the scheduled meeting (e.g., has a television display and white board that the creator has not indicated as being needed for the meeting). Accordingly, the notification 502 may also indicate that there is another meeting that could use those resources. Thus, a selector 504 may also be presented and may be selectable (e.g., using touch input) to accept a suggested swap to “Room 2” as may be noted on the selector 504 itself. Based on selection of the selector 504, the electronic reservation system may then be updated accordingly by updating assigned rooms for the respective meetings and even transmitting notifications (e.g., emails) to all participants of each meeting notifying them of the change. A notification may also be transmitted to the creator of the other meeting notifying him or her that their meeting will now take place in the room that was just given up.

Note further that a selector 506 may also be provided as part of the GUI 500, with the selector 506 being selectable to decline the suggested room swap. Additionally, or alternatively, the selector 506 may be selectable for the creator's personal device to access the electronic reservation system so that the creator can be presented with a page at which the electronic reservation may be updated to indicate that the creator's meeting will in fact use the resources that the electronic reservation system indicated as not being used.

FIG. 6 shows another example GUI 600 presenting another example notification 602. The notification 602 might be presented on the personal device of a meeting creator that has already booked a room for a given meeting but is being notified that an automatic swap to a different room than the one the creator has already booked has been performed. As may be appreciated from FIG. 6, the notification 602 may indicate that the room the creator has reserved exceeds the requirements for the scheduled meeting. Accordingly, the notification 602 may also indicate that there is another meeting that could use those resources and that an automatic switch of the creator's meeting to a different room (e.g., “Room 5”) has already been performed. However, also note that a selector 604 may be presented, with the selector 604 being selectable to request a room swap back to the room previously reserved by the creator. Thus, selection of the selector 604 may cause a notification to be transmitted to the personal device of the creator of the other meeting to request this other room swap.

FIGS. 7-9 respectively show example GUIs 700, 800, and 900 that may be presented on the display of a meeting creator's personal device when attempting to book a meeting in the first place via an electronic reservation system in accordance with present principles. Beginning first with FIG. 7, a notification 702 may be provided as part of the GUI 700 and it may indicate that the room the creator is trying to book exceeds or does not meet the meeting requirements indicated by the creator. For example, the room sought to be booked might have a conferring hub for remote meeting attendees to call in to the meeting even though the creator indicated that all attendees will be in-person attendees, or the room might be too small for the number of attendees indicated by the creator.

In order to match the creator's meeting with a room that better suits the meeting's needs, the creator may be given an option via selector 704, where selector 704 may be selectable to switch from the requested room to “Room 8”, which also meets the meeting's requirements but allows the room the creator is trying to reserve to remain available so that another meeting might be scheduled in the future for that room. Also note that a selector 706 may be presented, which may be selectable to automatically change a requirement for the meeting that the system has identified as potentially being changeable, such as switching attendee Axel from status as an in-person attendee to status as a remote attendee based on a determination by the system that Axel is logged in or otherwise connected to the system from a different country and hence is likely to not attend the meeting in person. The system may use still other ways to determine that Axel might be a remote attendee, such as using GPS coordinates from his personal device that have been transmitted to the system and indicate presence in a different country than where the meeting is to take place, or accessing data in a database that indicates the different country as the location of Axel's primary office to thus assume he will not be an in-person attendee.

FIG. 8 shows the aforementioned GUI 800, with the GUI 800 including a notification 802 that no room is available at the creator's requested meeting date and time that conforms to the requirements of the meeting. However, owing to the electronic reservation system being able to locate another room already reserved for another meeting that happens to meet the creator's requirements, a selector 804 may also be presented as part of the notification 802 and may be selectable to request a room swap with the other meeting to move the creator's meeting to “Room 7”, which is where the other meeting is currently scheduled to occur. Selection of the selector 804 may thus cause presentation of a swap request to the creator of the other meeting, e.g., to present a GUI similar to the GUI 500 described above to the creator of the other meeting.

Moving on to FIG. 9, it shows the GUI 900 referenced above. The GUI 900 may include a notification 902 that no room is available at the creator's requested meeting date and time that conforms to the requirements of the meeting. Differentiating this example from FIG. 8, the GUI 900 may also include a selector 904 that is selectable to broadcast a swap request to the creators of other meetings that are scheduled to occur at the same date and time in meeting rooms that do in fact conform to those requirements. Thus, the selector 904 may be selectable to transmit notifications to the respective personal devices of plural other meeting creators rather than targeting a single creator that has reserved another room that meets the requirements. A room swap may then be performed should one of the other meeting creators accept the broadcasted swap request.

Moving on to FIG. 10, it shows an example GUI 1000 that might be presented on the display of a user's personal device or on the display of a conferencing hub device located within a given meeting room. The GUI 1000 may be presented based on the conferencing hub device detecting a user within the room via sensor input as described herein despite no meeting being booked for the room during the current time, thus making the user a room squatter. However, note that people (e.g., squatters) may also be detected within a certain room even if sensor input from, e.g., an IR proximity sensor or camera is not available. For instance, other Internet of things-based sensors may be used, Bluetooth or Wi-Fi communications may be detected and used to assume user presence, current use of a display within the room may be detected to assume user presence, telephone use using a conferencing hub device may be detected to assume user presence, microphone input received at a hub device may be used to identify words as being spoken and hence assume user presence, etc.

Additionally, or alternatively, the GUI 1000 may be presented based on the hub device detecting that not all of the room's resources are being optimally used. For example, should the room be reserved for a certain meeting for a certain number of people, but less than that number of people actually show up for the meeting, the conferencing hub device may detect the number of people that actually showed up to the room for the meeting and determine that the room accommodates more people than are actually present.

Thus, as depicted in FIG. 10, assume for example that less than four meeting attendees or squatters are present in the room, resulting in the example notification 1002 being presented. As shown, the notification 1002 may indicate that the room is more suitable for four or more meeting participants (as might be input into the system by a system administrator) and therefore that the person(s) currently in that room will have to move out of that room should another meeting attempt to be booked that has four or more attendees. However, to avoid that inconvenience, the GUI 1000 may include a selector 1004 that may be selectable to provide a command to the electronic reservation system to automatically reserve another room (“Room 10”) for those people/squatters so that the people/squatters may reserve that room, pack their things, and then head over to that other room rather than waiting for another person to first attempt to book the room in which they are currently disposed.

FIG. 11 shows an example GUI 1100 that may be presented on a display accessible to one or more of the devices disclosed herein, e.g., the display of a conferencing hub device, the display of a user's personal device, the display of an electronic reservation system administrator's personal device, etc. The GUI 1100 may be presented for configuring settings associated with the electronic reservation system.

For example, the GUI 1100 may include a first setting 1102 that may be selectable via the adjacent check box to enable the electronic reservation system to undertake actions in relation to room swapping as disclosed herein. For example, selection of the setting 1102 may configure a server and/or conferencing hub device to undertake the logic of FIG. 4 as well as to facilitate presentation of the notifications as described herein. The GUI 1100 may also include a second setting 1104 that may be selectable via its adjacent check box to enable the electronic reservation system to specifically perform automatic room swaps as disclosed herein rather than requesting room swaps.

Moving on from FIG. 11, it is to be understood that the GUIs of FIGS. 5-10 may be presented as pop-up GUIs on a user/creator's personal device (e.g., a laptop computer or smart phone associated with the user as indicated in the electronic reservation system). Additionally, or alternatively, the GUIs of FIGS. 5-10 may be sent as part of an email to the respective user/creator so that the user/creator may be presented with the respective GUI as part of the email.

Still further, notifications in accordance with present principles may also be presented audibly to users/creators. For example, the content of the notification described above in reference to FIG. 10 may be presented audibly via a speaker on a hub device within a particular room in which a squatter is detected as present.

Additionally, the present application recognizes that present principles apply to more than reservations for just rooms. For example, the electronic reservation system may manage reservations for other locations such as building lobbies, outside areas, etc. It may now be appreciated that present principles provide for an improved computer-based user interface(s) that improves the functionality and ease of use of electronic reservation systems. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
at least one processor; and
storage accessible to the at least one processor and comprising instructions executable by the at least one processor to:
identify at least one factor related to an electronic reservation for a first meeting room; and
provide an electronic notification suggesting a room swap to a second meeting room for the electronic reservation, the second meeting room being different from the first meeting room.

2. The first device of claim 1, wherein the instructions are executable by the at least one processor to:
provide the electronic notification by transmitting the electronic notification to a second device different from the first device, the second device associated with a person that created the electronic reservation.

3. The first device of claim 1, wherein the instructions are executable by the at least one processor to:
provide the electronic notification by presenting the electronic notification on a display.

4. The first device of claim 1, where the instructions are executable by the at least one processor to:
identify at least one meeting requirement based on input from a user that created the electronic reservation, the at least one meeting requirement at least in part establishing the at least one factor; and
provide the electronic notification suggesting the room swap to the second meeting room based on the second meeting room conforming to the at least one meeting requirement.

5. The first device of claim 4, wherein the at least one meeting requirement pertains to physical space for accommodating a number of in-person meeting participants.

6. The first device of claim 4, wherein the at least one meeting requirement pertains to availability of at least one room resource specified by the user.

7. The first device of claim 6, wherein the at least one room resource comprises one or more of: a white board, a conference phone device, a display.

8. The first device of claim 4, wherein the at least one meeting requirement pertains to one or more of: a particular building in which a meeting is to be held, a particular floor of a particular building in which the meeting is to be held.

9. The first device of claim 4, wherein the at least one meeting requirement pertains to room availability for a particular date and time.

10. The first device of claim 1, wherein the electronic notification comprises a selector that is selectable to accept the room swap.

11. A method, comprising:
identifying at least one need related to a meeting that is associated with a first meeting location, the need indicated in an electronic reservation system;
providing an electronic notification suggesting a swap to conduct the meeting at a second meeting location instead of the first meeting location, the second meeting location being different from the first meeting location.

12. The method of claim 11, comprising:
providing the electronic notification by transmitting the electronic notification to a device associated with a person that is creating or has created an electronic reservation for the meeting.

13. The method of claim 11, comprising:
providing the electronic notification by presenting the electronic notification on a display, the electronic notification comprising a selector that is selectable to accept the suggestion.

14. The method of claim 11, comprising:
providing the electronic notification suggesting the swap based on the second meeting location conforming to the at least one need.

15. The method of claim 14, wherein the at least one need pertains to physical space for accommodating a number of in-person meeting participants as opposed to accommodating all meeting participants, all meeting participants comprising meeting participants that will not attend the meeting in person.

16. The method of claim 14, wherein the at least one need pertains to availability of at least one location resource.

17. The method of claim 16, wherein the at least one location resource comprises one or more of: a white board, a conference phone device, a display.

18. A computer readable storage medium (CRSM) that is not a transitory signal, the computer readable storage medium comprising instructions executable by at least one processor to:
determine a first location for a first meeting based on one or more meeting needs indicated by a first user; and
provide an electronic notification to a device associated with a second user, the electronic notification indicating a location swap for a second meeting already scheduled to occur at the first location at a same date and same time as the first meeting, the location swap being from the first location to a second location different from the first location.

19. The CRSM of claim 18, wherein the electronic notification suggests the location swap.

20. The CRSM of claim 18, wherein the electronic notification indicates that the location swap has already been performed.
